(19) United States
(12) Patent Application Publication
(10) Pub. No.: US 2023/0349674 A1
(43) Pub. Date: Nov. 2, 2023

(54) METHODS AND APPARATUS FOR DRONE DEPLOYMENT OF NON-LETHAL VEHICLE STOPPING COUNTERMEASURES

(71) Applicant: Lawrence Corban, McDonough, GA (US)

(72) Inventor: Lawrence Corban, McDonough, GA (US)

(21) Appl. No.: 18/133,571

(22) Filed: Apr. 12, 2023

Related U.S. Application Data
(60) Provisional application No. 63/330,313, filed on Apr. 13, 2022.

(51) Int. Cl. F41H 13/00; B64D 1/02

(52) U.S. Cl. CPC F41H 13/0006; B64D 1/02; B64U 2101/16

(57) ABSTRACT

A drone comprises a plurality of barrels pointed symmetrically around a center point on the drone. The barrels are loaded with projectiles that are each attached to a tensile countermeasure. The tensile countermeasure is loaded into an aerodynamic fairing that is then attached to the drone. The drone takes-off and transitions to high-speed flight. While flying at high speed, the aerodynamic fairing is ejected from the drone, releasing the tensile countermeasure stored inside. Once released from storage in the aerodynamic fairing, the tensile countermeasure remains attached to the drone through the projectiles still lodged in the barrels, trailing behind the drone in the open air. The drone continues to maintain high speed flight until it reaches the desired trigger location, at which time the projectiles are ejected from the barrels causing the countermeasure to expand at the desired target location.

### CROSS REFERENCE TO RELATED APPLICATIONS

This application claims priority to Appl. Ser. No. 63/330,313 filed Apr. 13, 2022, the contents of which are incorporated in their entirety.

### STATEMENT REGARDING FEDERALLY SPONSORED RESEARCH OR DEVELOPMENT

This invention was made with government support under contract #M6785419C6701 awarded by MARCORSYSCOM.

### BACKGROUND

To maintain security of certain environments, interdiction of non-compliant boats and drones is necessary. In peace-time environments, non-lethal, low-collateral damage, boat, and drone stopping countermeasures are preferred, leaving lethal force as the absolute last resort. Pneumatic line and net throwing devices are commonly used in this role to deploy countermeasures in front of a moving vehicle that will cause the vehicles propulsion system to seize or otherwise lose power.

Patent EP3025116B1 describes various boat stopping countermeasures and a pneumatic line throwing device used to deploy said boat stopping countermeasures. When placed in the correct position in front of a target boat, the line throwing device releases compressed air to shoot one end of a boat stopping countermeasure out of a barrel, causing the length of the countermeasure to expand in front of the target boat. Patent EP3025116B1 also describes a multi-barrel system that shoots two projectiles in opposite directions, each projectile being attached to the other by the same countermeasure. In all cases, the countermeasure remains stored in the launcher until after the projectiles are ejected from the barrels. As a result, a portion of the energy stored in the projectiles as they are ejected from the barrels is expended to remove the countermeasure from storage in the launching device. In cases where a large countermeasure is tightly loaded into a small storage space, the force required to remove the countermeasure from storage can be significant.

Patent US20170356726A1 describes a drone equipped with a net launcher capable of launching the net over non-compliant drones. Various configurations of drones outfitted with netguns are disclosed. Each of the configurations is common in that the net launching device stores the net inside and launches a plurality of projectiles that in-turn pull the net from storage and propel it away from the drone.

Patent US8205537B 1 describes a net countermeasure designed for deployment at high speed from a missile. A net launching method is disclosed that requires simultaneous ignition of two separate charges, one to remove the net from storage, and one to launch the projectiles. In this method, the projectiles are not used to pull the net from storage, but a second charge, or stored energy device, is required to remove the net from storage.

### SUMMARY OF THE INVENTION

The present inventions relate to non-lethal vehicle stopping countermeasures, and, more particularly, methods and apparatus for deploying non-lethal vehicle stopping countermeasures from a drone.

### BRIEF DESCRIPTION OF THE DRAWINGS

The details of the preferred embodiments will be more readily understood from the following detailed description when read in conjunction with the accompanying drawings wherein:

FIG. 1 illustrates a bottom view of projectiles being loaded into a plurality of barrels that are pointed radially around the body of an interceptor drone.

FIG. 2 illustrates a side view of a loop of tensile material being stuffed into an aerodynamic fairing.

FIG. 3 illustrates a side view of the aerodynamic fairing being attached to the interceptor drone.

FIG. 4 illustrates a side view of the interceptor drone with aerodynamic fairing attached.

FIG. 5 illustrates an orthogonal view of the interceptor drone flying at high speed with the aerodynamic fairing attached.

FIG. 6 illustrates the interceptor drone at high-speed ejecting the aerodynamic fairing.

FIG. 7 illustrates a rear view of the interceptor drone at high-speed trailing the tensile material.

FIG. 8 illustrates a bottom view of the interceptor drone at high speed while projectiles are ejected from the barrels.

FIG. 9 illustrates tensile material ejected from the interceptor drone stretching open with the force from the ejected projectiles.

FIG. 10 illustrates an orthogonal view of the tensile countermeasure fully open at the desired point of intercept.

FIG. 11 illustrates a side view of a drone landing on the ground with and without the aerodynamic fairing.

FIG. 12 is a block diagram of the novel method for deploying a tensile countermeasure from a drone.

FIG. 13 is a Block diagram representing each of the main system elements.

### DETAILED DESCRIPTION OF THE PREFERRED EMBODIMENTS

The present inventions are illustrated by way of example and are not limited by the accompanying figures, in which like references indicate similar elements. Elements in the figures are illustrated for simplicity and clarity and have not necessarily been drawn to scale.

A new method for deploying non-lethal countermeasures from a high-speed interceptor drone is needed that uses aerodynamic force to remove the net from storage, and therefore does not require the inertia of the projectiles, or a second stored energy device to remove the net from storage. This allows for significant miniaturization of the net launching device for a given size and weight net.

A tensile counter measure is stored in an aerodynamic fairing that can be ejected from the drone in flight. Once ejected, the fairing rapidly decelerates due to aerodynamic drag which in turn pulls the countermeasure, still attached to drone, from storage inside the aerodynamic fairing as it falls away. That is, it uses the aerodynamic drag on the ejected fairing to pull the countermeasure from storage in the launching device before the projectiles are launched from the barrels. This allows all the energy stored in the projectile launching device to be applied to expanding the counter measure, reducing the energy storage capacity required of the launching device for a given size and weight countermeasure.

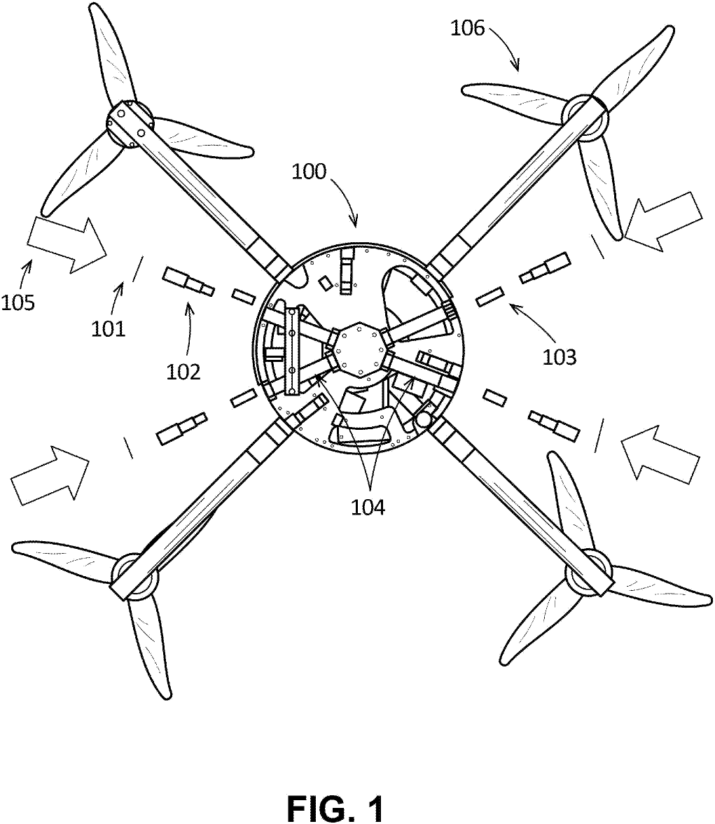

FIG. 1 illustrates the bottom view of a multi-rotor drone 100. In this embodiment the drone comprises a plurality of barrels 104 that are pointed radially around the main frame of the drone 100. The barrels 104 are attached to the bottom of the drone 100 behind the propellers 106. In one embodiment, each barrel 104 comprises a projectile 102, spacer 103, and membrane 101. The arrows 105 illustrate the projecctiles being loaded into each barrel 104. In another embodiment, a projectile 102 is loaded into the barrel 104 first, followed by a spacer 103. An adhesive backed membrane 101 is then used to cover the muzzle of the barrel 104 such that the spacer 103 keeps the projectile 102 fully seated at the bottom of the barrel 104 and unable to fall out of place due to gravity. The thickness and material of the membranes101 are designed to rupture from the impact of the projectile 102 when launching out of the barrel 104. The adhesive backing on the membrane is designed to stick to the muzzle of the barrel.

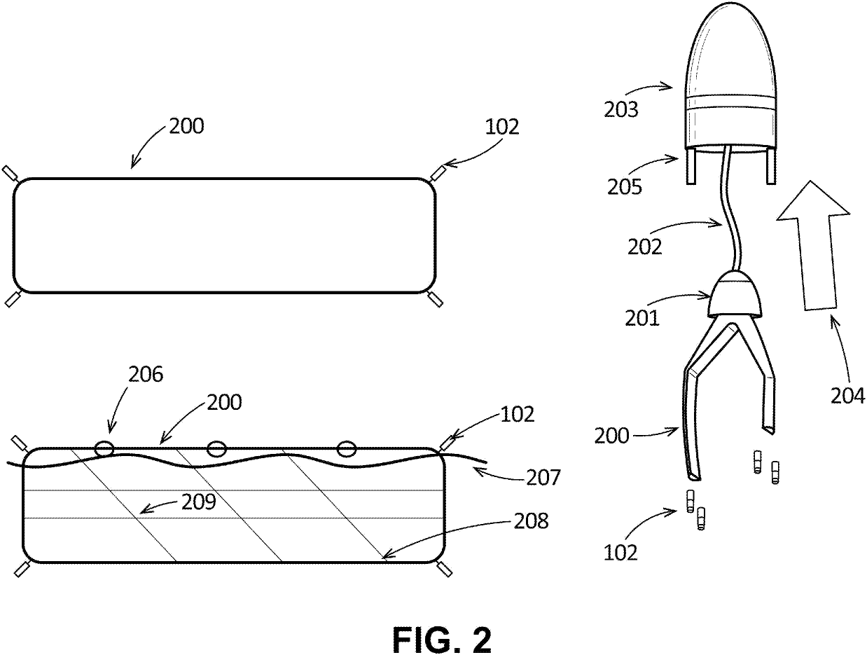

FIG. 2 illustrates a loop 200 made of tensile material. A plurality of projectiles 102 are attached to the loop 200. The arrow 204 illustrates the loop 200 being stuffed into an aerodynamic fairing 203. In some embodiments, the loop 200 is stuffed into a bag 201, before being stuffed into the aerodynamic fairing 203. In some embodiments, the bag 201 is attached to the aerodynamic fairing 203 by a rope 202. In some embodiments, springs 205 can be attached to the top of the aerodynamic fairing. The springs 205 can mate with the bottom of the drone 100 such that they push the aerodynamic fairing away from the body of drone 100 when the aerodynamic fairing is electromechanically released. In another embodiment, a plurality of floats 206 and weights 208 can be attached to the loop 200 in a way that causes one portion of the loop to float on top of the water line 207, and another portion to sink below the waterline 207 when deployed over water. Further, the inner area of the loop 200 can be filled with netting 209.

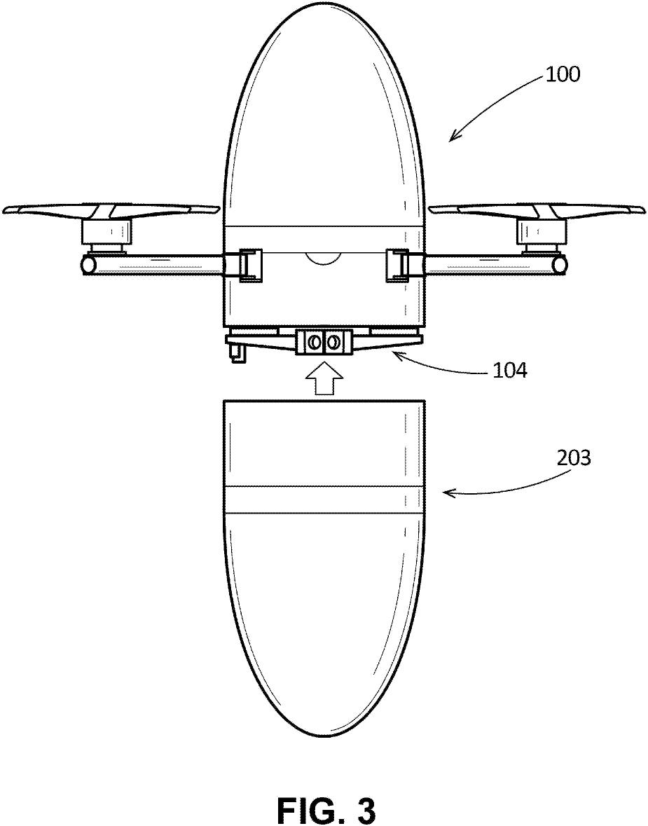

FIG. 3 illustrates the aerodynamic faring 203, with loop 200 stored inside, being attached to the bottom of the drone 100. The fairing 203 is attached to the bottom of the drone with one or more electromechancial releases. In some embodiments, the aerodynamic fairing 203 covers the muzzles of the barrels 104 when installed on the drone. When the muzzles of the barrels 104 are covered by the aerodynamic fairing 203 personell working around the drone before takeoff are safe from an accidental launch of the projectiles 102 because they will be arrested by the aerodynamic fairing 203 before leaving the barrels 104.

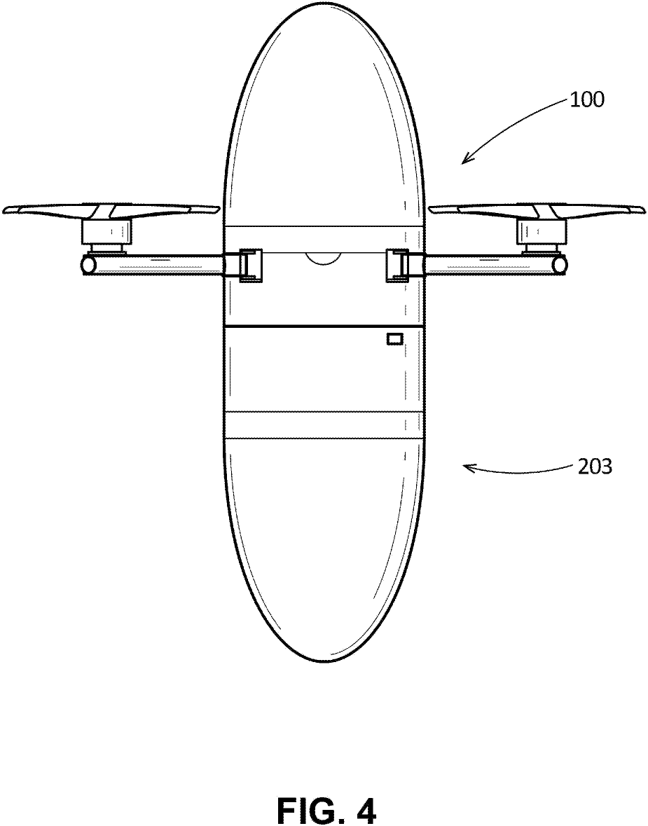

FIG. 4 illustrates the drone 100 with aerodynamic fairing 203 installed. Note that the aerodynamic fairing 203 covers the muzzles of the barrels 104 when installed.

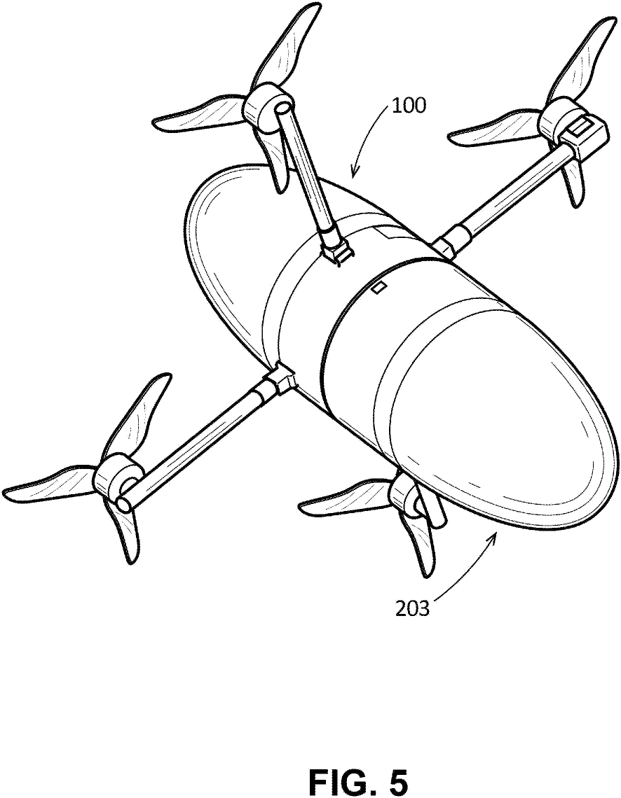

FIG. 5 illustrates the drone 100 flying at high speed with the aerodynamic fairing 203 installed with the loop 200 stored inside.

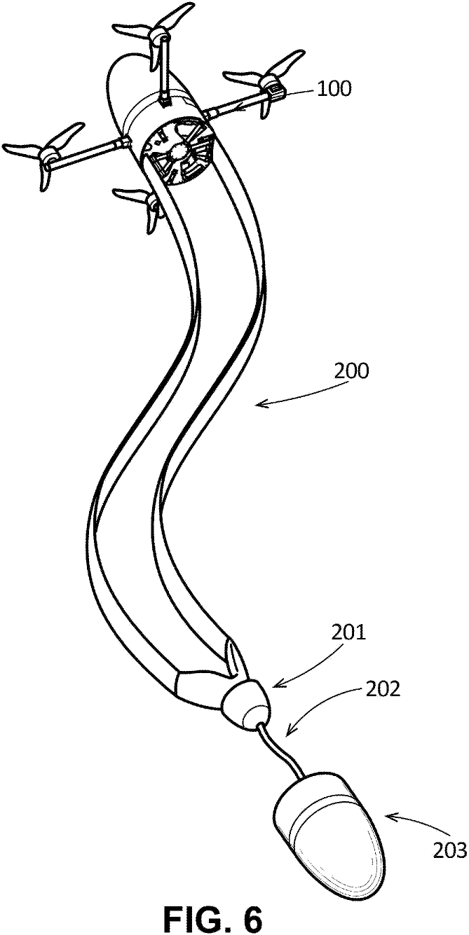

FIG. 6 illustrates the aerodynamic fairing 203 being ejected from the back of the drone 100 while flying a high speed. The aerodynamic fairing is released electromechanically, and seperated from the drone 100 by the springs 205 or some other stored energy device. Without a stored energy device forcing the fairing to separate from the drone, aerodynamic forces behind the drone will prevent the aerodynamic fairing 203 from seperating from the drone 100 causing the countermeasure deployment to fail. Once the aerodynamic fairing 203 is seperated from the drone 100, aerodynamic drag causes it to decelerate, in turn pulling the loop 200 out of storage inside the aerodynamic fairing. In some embodiments, the aerodynamic fairing 203 is ejected from the drone 100 with the loop 200 stored inside a bag 201. In this embodiment, the bag 201 is attached to the fairing 203 such that the drag force on the fairing 203 is transferred to the bag 201 through the rope 202 in order to pull the loop 200 out of the bag 201 as the fairing 203 falls away.

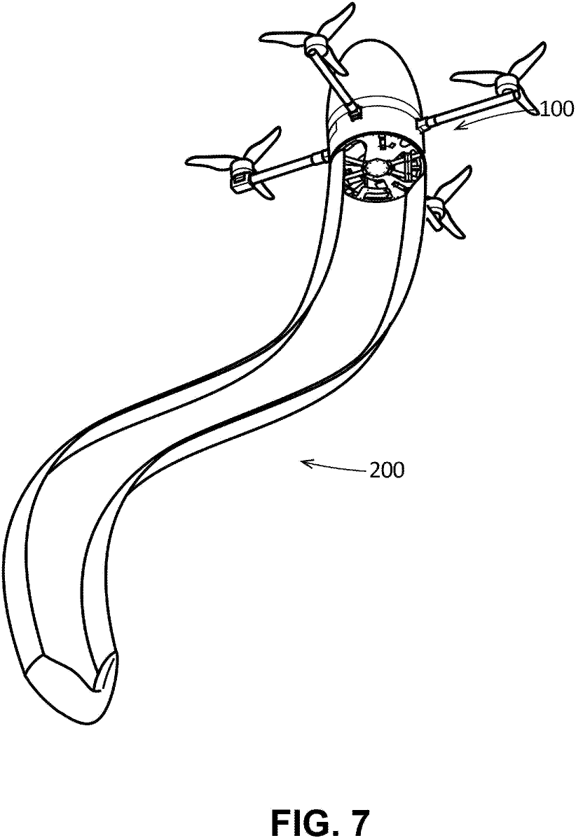

FIG. 7 illustrates the drone 100 continuing to fly at high speed, after ejecting the fairing 203, with the loop 200 still attached. After ejecting the fairing 203, the loop 200 remains attached to the drone 100 by the projectiles 102 still lodged in the barrels 104. In some embodiments, the projectiles are held in the barrels 104 after the fairing 203 is ejected by the membranes 101 installed on the muzzle of the barrels 104. In this embodiment, the membranes 101 material and thickness is selected to not rupture due to the drag force imposed on the projectiles 102 by the loop 200 trailing behind the drone 100 at high speed.

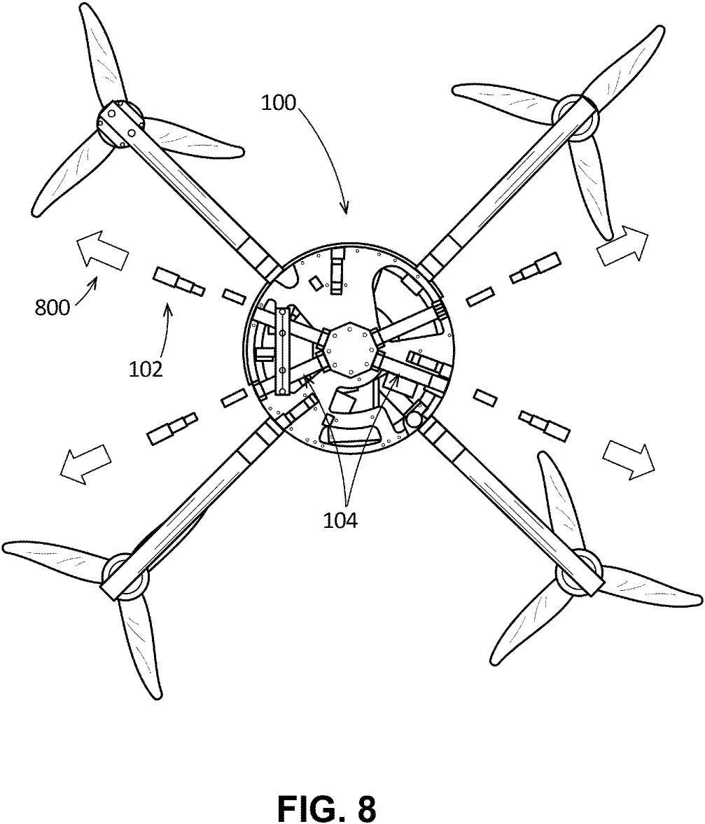

FIG. 8 illustrates a bottom view of the drone 100 in flight as the projectiles 102 are ejected 800 out of the barrels 104. The projectiles 102 can be pneumatically or explosively launched out of the barrels 104. After being ejected out of barrels 104, the projectiles 102 resulting inertia expands the loop 200 at the desired intercept location. Before the projectiles are ejected from the barrels, a computer onboard the drone 100 calculates an estimate of when, in time and or space, the loop 200 will reach the desired intercept location, fully expanded, after the projectiles are ejected from the barrels. The period of time the loop takes to expand after the projectiles are ejected is constant, but the closing velocity between the drone and its target is variable. To solve for this, the computer reads sensor data from one or more sensors mounted on the drone to compute closing velocity between target and interceptor drone, adjusting the estimate accounting for this variable. When the drone reaches the estimated trigger location in time or space, the computer commands the projectile ejection system to eject the projectiles out of the barrels. The ejection system can be pneumatic or explosive, propelling high velocity liquid or gas to accelerate the projectiles out of the barrels.

In some embodiments the projectiles are launched when the loop is pulled completely out of storage in the fairing. In some embodiments, the projectiles are launched when the loop is partially pulled out of storage in the fairing. In both embodiments, the projectiles are launched after the loop has begun to exit storage.

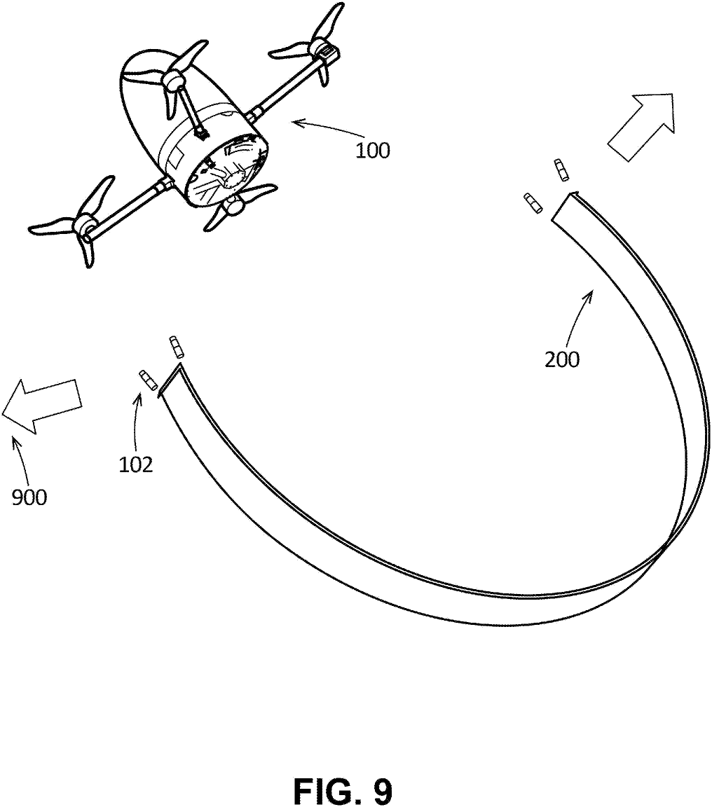

FIG. 9 illustrates the drone 100 continuing to fly at high speed after the projectiles are ejected out of the barrels. At this point the loop 200 is detached from the drone 100 and begins to decellerate due to aerodynamic drage. The arrows 900 illustrate the inertia of the projectiles expanding the loop 200 at the desired intercept location.

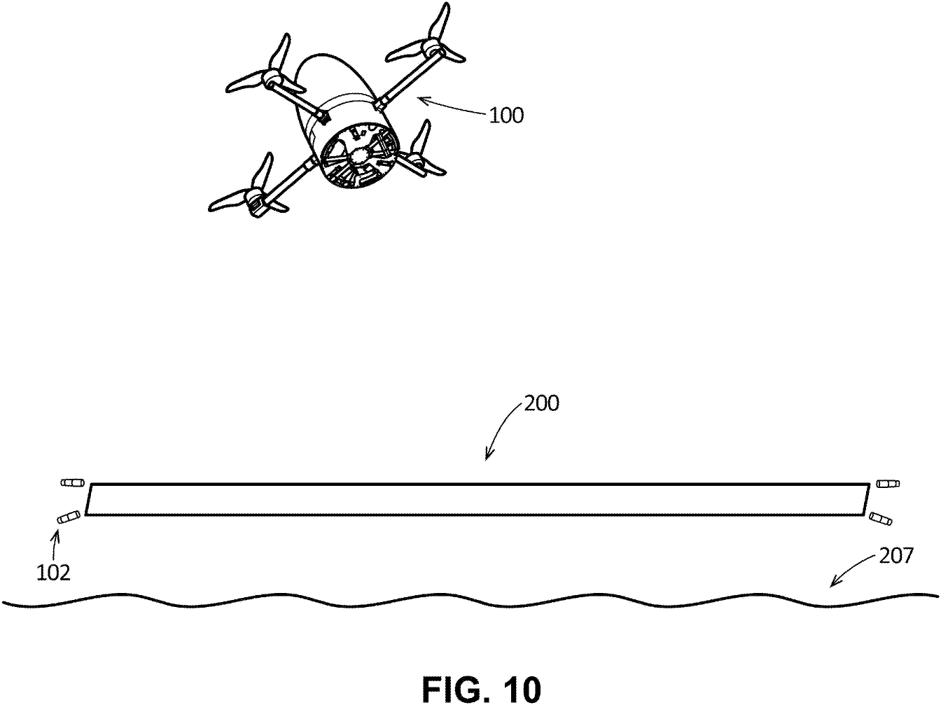

FIG. 10 illustrates the loop 200 fully expanded at the desired intercept location as the drone 100 continues flying at high speed without pause. In some embodiments involving deployment of an anti-vehicle net over water the desired location is located just over the waterline 207.

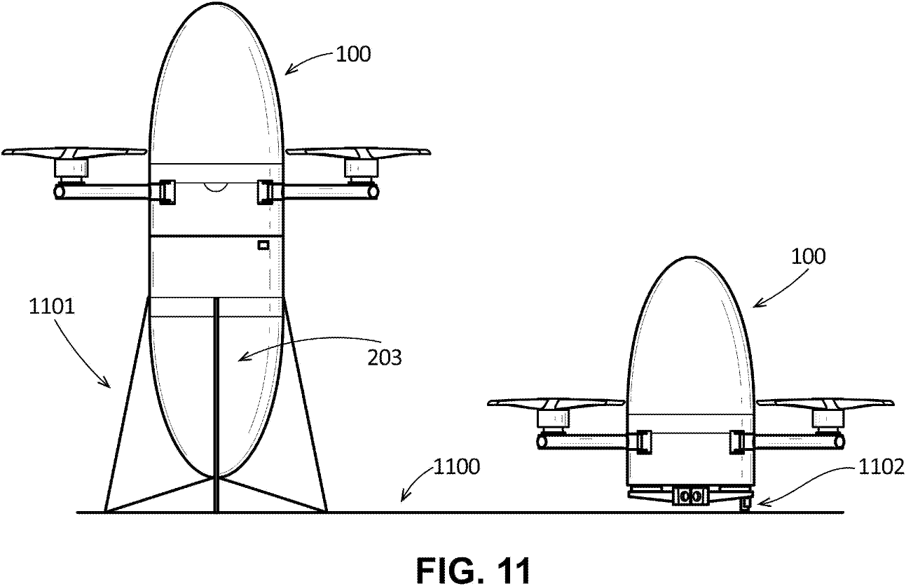

FIG. 11 illustrates the drone 100 sitting on the ground 1100 with and without aerodynamic fairing 203 installed. In this embodiment of the invention, the aerodynamic faring 203 comprises feet 1101 to allow the drone to take off and land with aerodynaimc fairing 203 installed. Likewise the drone 100 comprises feet 1102 to allow the drone to land on the ground after the fairing 203 has been ejected. After deploying the loop 200, the drone 100 can return to land directly on the ground, or any other take off and landing surface, to be reloaded for a new loop 200, and fairing 203 for a next mission.

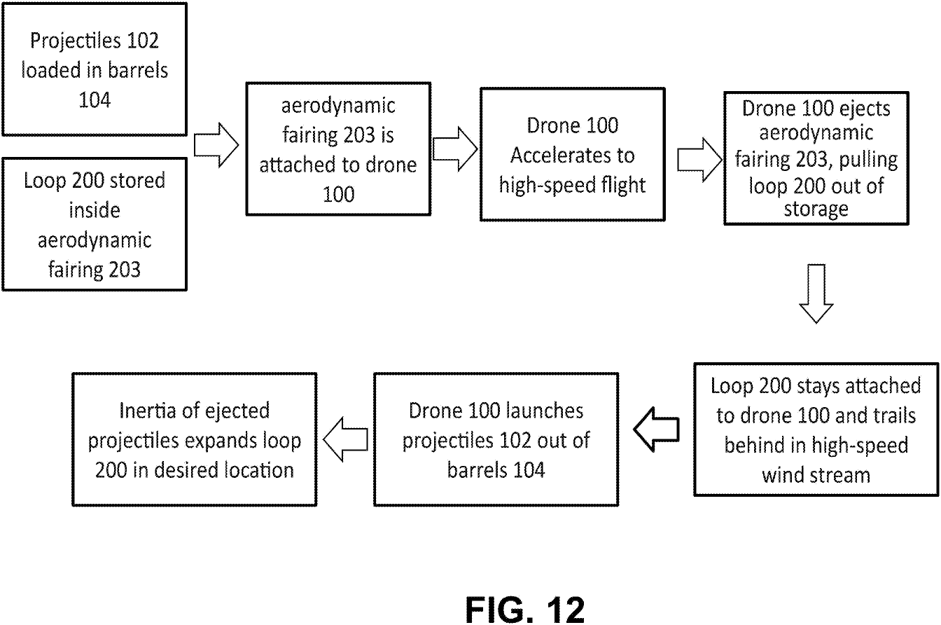

FIG. 12 is a block diagram summarizing one method embodiment for deploying a tensile countermeasure from a drone.

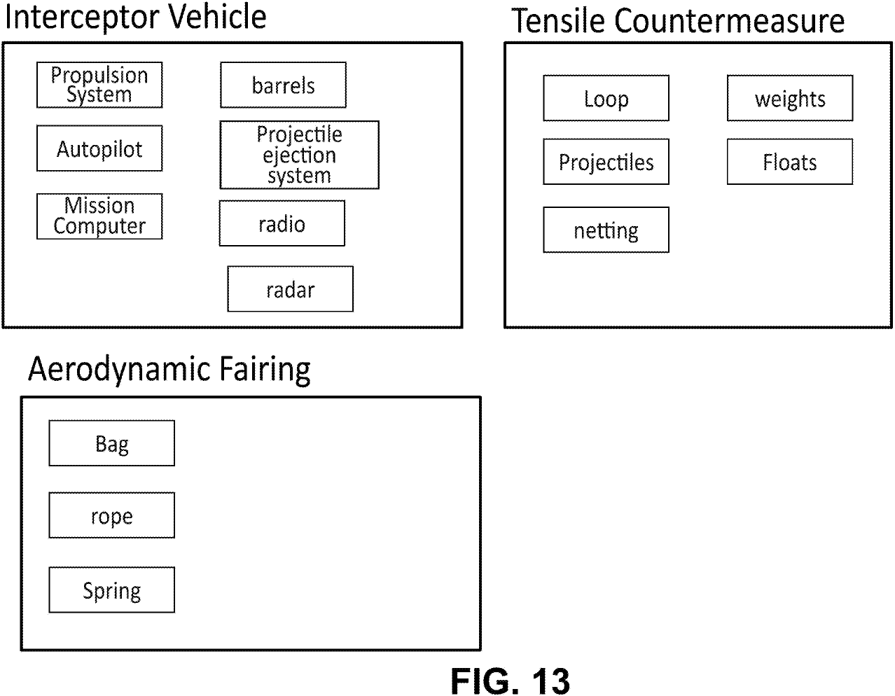

FIG. 13 is a Block diagram summarizing the main elements in one embodiment of the system.

In some embodiments the drone is commanded to eject the projectiles by an onboard computer that reads sensor data generated by sensors mounted onboard the drone to compute an estimated time to target. In some embodiments the sensor is comprised of an onboard radar. In some embodiments the computer commands the ejection or the projectiles at a prescribed time before or after the estimated time to target. In some embodiments, the computer estimates the closing velocity between the two vehicles, target and interceptor, using sensor data from the radar or other seeker onboard the interceptor to adjust the prescribed time to eject the projectiles, using closing velocity as a variable. In some embodiments the drone is commanded to eject the projectiles by a remote operator through a wireless communication link.

In some embodiments the tensile countermeasure can be deployed from a manned aircraft or other vehicle, manned or unmanned, such as a watercraft or ATV.

In some embodiments the loop is pulled out of storage by aerodynamic drag on itself or the bag without being attached to the aerodynamic fairing. In some embodiments, the bag can be attached to a drogue parachute that deploys after ejecting the fairing to pull the loop out of the bag, wherein the bag is attached to the drogue shoot by the rope.

In some embodiments the plurality of barrels are pointed in a symmetric pattern around a central point on the unmanned aircraft.

In some embodiments the rope is embodied as a filament or string or a chain or a chord.

Any letter designations such as (a) or (b) etc. used to label steps of any of the method claims herein are step headers applied for reading convenience and are not to be used in interpreting an order or process sequence of claimed method steps. Any method claims that recite a particular order or process sequence will do so using the words of their text, not the letter designations.

Unless stated otherwise, terms such as “first” and “second” are used to arbitrarily distinguish between the elements such terms describe. Thus, these terms are not necessarily intended to indicate temporal or other prioritization of such elements.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure.

What is claimed is:

1. A method for deploying a tensile countermeasure from an interceptor drone comprising the following steps:
loading a plurality of projectiles into a plurality of barrels that are pointed radially around the center of a drone interceptor vehicle, wherein each of the projectiles is attached to a singular tensile countermeasure;
stuffing a tensile countermeasure into an aerodynamic fairing;
attaching an aerodynamic fairing to the interceptor vehicle;
flying the interceptor vehicle to high speed;
ejecting the aerodynamic fairing from the interceptor vehicle while maintaining high speed;
trailing the tensile countermeasure behind the interceptor vehicle at high speed with the projectiles still lodged in the barrels; and
ejecting the projectiles from the barrels to expand the tensile countermeasure in the desired intercept location.

2. The method of claim 1 wherein a spacer is loaded into each of the barrels after the projectile.

3. The method of claim 2 wherein a membrane is installed over the end of each barrel after the spacer is loaded.

4. The method of claim 1 wherein the tensile countermeasure is stuffed into a bag before it is stuffed into the aerodynamic fairing.

5. The method of claim 4 wherein the aerodynamic fairing is attached to the bag with a rope, wherein the bag is pulled off the net by the drag force on the aerodynamic fairing after it is ejected.

6. The method of claim 5 wherein the aerodynamic fairing is ejected from the interceptor using a spring force.

7. The method of claim 6 wherein a spacer is loaded into each of the barrels after the projectile.

8. The method of claim 7 wherein a membrane is installed over the end of each barrel after the spacer is loaded.

9. The method of claim 1 wherein a computer commands the ejection of the projectiles by measuring closing velocity with the target to estimate the correct trigger location in time or space by accounting for the portion of time needed for the loop to fully expand after the projectiles are launched such that the target collides with the loop when fully expanded.
